(19) United States
(12) Patent Application Publication
(10) Pub. No.: US 2006/0155786 A1
(43) Pub. Date: Jul. 13, 2006

(54) Recording medium, and method and apparatus for reproducing data from recording medium using local storage

(76) Inventors: Kang Soo Seo, Anyang-si (KR); Jea Yong Yoo, Seoul (KR); Byung Jin Kim, Seongnam-si (KR)

Correspondence Address: HARNESS, DICKEY & PIERCE, P.L.C., P.O. BOX 8910, RESTON, VA, 20195, US

(21) Appl. No.: 11/325,458

(22) Filed: Jan. 5, 2006

Related U.S. Application Data
(60) Provisional application No. 60/642,114, filed on Jan. 10, 2005.

(30) Foreign Application Priority Data
May 20, 2005 (KR) 10-2005-0042545

(51) Int. Cl. G06F 12/00; G06F 17/30

(52) U.S. Cl. 707/204

(57) ABSTRACT

A recording medium, and a method and apparatus for reproducing data from a recording medium using a local storage is disclosed. The recording medium includes: a first area for storing content data; and a second area for storing first identification (ID) information capable of identifying a content provider (CP) and second identification (ID) information capable of identifying the corresponding recording medium manufactured by the content provider (CP). The method for reproducing data from a recording medium using a local storage includes the steps of: a) reading a directory name for identifying a content provider recorded in the recording medium and a directory name for identifying the recording medium; b) recognizing a binding unit contained in a local storage directory having the same directory name as the read directory name; c) binding the binding unit with files contained in the recording medium, and forming a virtual package; and d) reproducing content data stored in the recording medium and content data stored in the local storage using the virtual package.

This application claims the benefit of Korean Patent Application No. 10-2005-0042545, filed on May 20, 2005, which is hereby incorporated by reference as if fully set forth herein.

This application claims the benefit of U.S. Provisional Application No. 60/642,114 filed on Jan. 10, 2005, in the name of inventors Jea Yong YOO, Kang Soo SEO and Byung Jin KIM, entitled “LOCAL STORAGE FOR HIGH DENSITY OPTICAL DISC”, which is hereby incorporated by reference as if fully set forth herein.

### BACKGROUND OF THE INVENTION

1. Field of the Invention

The present invention relates to a method and apparatus for reproducing data from a recording medium, and more particularly to a recording medium equipped with a specific area in which recording-medium directory information is recorded to combine the recording medium with a binding unit of a local storage, and a method and apparatus for reproducing data from the recording medium using the local storage contained in an optical recording/reproducing device.

2. Discussion of the Related Art

Generally, there has been widely used an optical disc acting as a recording medium capable of recording a large amount of data therein. Particularly, there has recently been developed a high-density optical recording medium capable of recording/storing high-quality video data and high-quality audio data for a long period of time, for example, a Blu-ray Disc (BD).

The BD based on the next-generation recording medium technique has been considered to be the next-generation optical recording solution capable of storing much more data than a conventional DVD. In recent times, many developers have conducted intensive research into the international standard technical specification associated with the BD along with those of other digital devices.

In association with the above-mentioned situation, there has recently been developed an optical recording/reproducing device based on the BD international standard, but the BD international standard has not yet been completed, such that many limitations and problems occur in developing the optical recording/reproducing device.

Particularly, the above-mentioned optical recording/reproducing device must consider not only a basic function for recording/reproducing data of the BD, but also an additional function for enabling the optical recording/reproducing device to interact with peripheral digital devices. In other words, the optical recording/reproducing device must receive an external input signal, must display the received signal, and must reproduce desired data using the external input signal and the BD.

However, an apparatus for reproducing data from the recording medium to simultaneously reproduce the external input signal and data of the BD has not yet been established, such that many limitations and problems occur in developing a BD-based optical recording/reproducing device.

### SUMMARY OF THE INVENTION

Accordingly, the present invention is directed to a recording medium, and a method and apparatus for reproducing data from a recording medium using a local storage that substantially obviate one or more problems due to limitations and disadvantages of the related art.

An object of the present invention is to provide a method and apparatus for reproducing content data recorded in a recording medium and content data recorded in a local storage.

Another object of the present invention is to provide a recording medium for storing content provider (CP) identification (ID) information and recording-medium ID information to effectively reproduce data of the recording medium and data of the local storage.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a recording medium comprises: a first area for storing content data; and a second area for storing first identification (ID) information capable of identifying a content provider (CP) and second identification (ID) information capable of identifying the corresponding recording medium manufactured by the content provider (CP).

In another aspect of the present invention, there is provided a method for reproducing data from a recording medium using a local storage comprising the steps of: a) reading a directory name for identifying a content provider recorded in the recording medium and a directory name for identifying the recording medium; b) recognizing a binding unit contained in a local storage directory having the same directory name as the read directory name; c) binding the binding unit with files contained in the recording medium, and forming a virtual package; and d) reproducing content data stored in the recording medium and content data stored in the local storage using the virtual package.

In yet another aspect of the present invention, there is provided a method for reproducing data from a recording medium using a local storage comprising the steps of: a) reading a directory name for identifying a content provider recorded in the recording medium and a directory name for identifying the recording medium; b) forming a directory having the same name as the read directory name in the local storage, downloading content data associated with the recording medium in the local storage directory, and storing the downloaded content data in the local storage directory; c) determining a binding unit on the basis of the downloaded content data, binding the determined binding unit with files contained in the recording medium, and forming a virtual package; and d) reproducing content data stored in the recording medium and content data stored in the local storage using the virtual package.

In yet another aspect of the present invention, there is provided an apparatus for reproducing data from a recording medium using a local storage comprising: a local storage for storing downloaded content data; and a controller which reads a directory name for identifying a content provider recorded in the recording medium and a directory name for identifying the recording medium, binds a binding unit contained in a local storage directory having the same directory name as the read directory name with files contained in the recording medium, forms a virtual package, and reproduces content data stored in the recording medium and/or content data stored in the local storage using the virtual package.

In yet another aspect of the present invention, there is provided an apparatus for reproducing data from a recording medium using a local storage comprising: a local storage for storing downloaded content data; and a controller which reads a directory name for identifying a content provider recorded in the recording medium and a directory name for identifying the recording medium, forms a local storage directory having the same directory name as the read directory name, stores the downloaded content data in the local storage directory, determines a binding unit on the basis of the downloaded content data, binds the determined binding unit with files contained in the recording medium, forma a virtual package, and reproduces content data stored in the recording medium and/or content data stored in the local storage using the virtual package.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptual diagram illustrating a method and apparatus for reproducing data from a recording medium according to the present invention;

FIG. 2 is a conceptual diagram illustrating a file structure recorded in an optical disc acting as a recording medium and a method for reproducing a specific title using the file structure according to the present invention;

FIG. 3 is a structural diagram illustrating a disc record structure of information associated with the file structure and areas for recording directory information according to the present invention;

FIG. 4A is a block diagram illustrating an optical recording/reproducing device according to the present invention;

FIG. 4B is a block diagram illustrating an apparatus for reproducing data using a local storage from among overall components contained in the optical recording/reproducing device shown in FIG. 4A according to the present invention;

FIG. 5 is a conceptual diagram illustrating a method for forming a virtual package according to the present invention;

FIGS. 6A˜6B show exemplary areas for recording directory information in a recording medium, specifically, examples for recording directory information in an index file (Index.bdmv) according to the present invention;

FIG. 7 shows an example in which additional data is stored in a local storage file structure according to the present invention;

FIG. 8 is a conceptual diagram illustrating a method for forming a virtual package using a virtual file system (VFS) on the basis of a file structure according to the present invention; and

FIG. 9 is a flow chart illustrating a method for reproducing data from a recording medium using a local storage, specifically, a method for reproducing data downloaded from an external part simultaneously with reproducing data of the recording medium, according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A method and apparatus for reproducing data from a recording medium using a local storage will hereinafter be described with reference to the annexed drawings.

Prior to describing the present invention, it should be noted that most terms disclosed in the present invention correspond to general terms well known in the art, but some terms have been selected by the applicant as necessary and will hereinafter be disclosed in the following description of the present invention. Therefore, it is preferable that the terms defined by the applicant be understood on the basis of their meanings in the present invention.

A recording medium for use in the present invention is indicative of all recordable mediums, for example, an optical disc, and a magnetic tape, etc., according to various recording schemes. It should be noted that the term “Disc” is considered to be the same as the recording medium according to the present invention.

For the convenience of description and better understanding of the present invention, the optical disc, such as a BD, will hereinafter be exemplarily used as the above-mentioned recording medium in the present invention. It should be noted that technical ideas of the present invention can be applied to other recording mediums without departing from the scope and spirit of the invention.

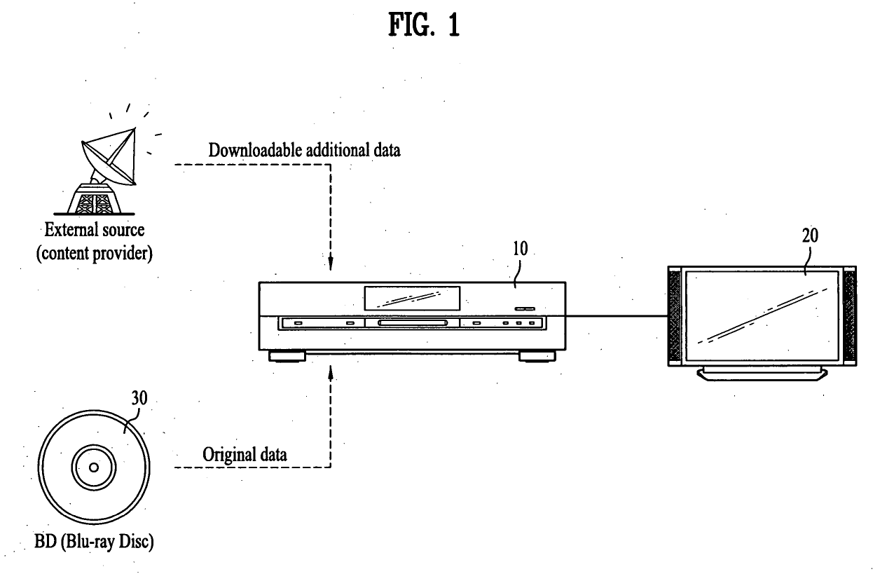

The term “local storage” is indicative of a storage unit contained in an optical recording/reproducing device 10 shown in FIG. 1. In more detail, the term “local storage” is indicative of a component capable of receiving necessary information or data from a user, and storing the received information or data. For example, a general local storage may be indicative of a Hard Disc Drive (HDD), but it should be noted that the term “local storage” of the present invention is not limited to the HDD, and is applicable to other examples as necessary.

Particularly, the term “local storage” is indicative of a storage unit for storing data associated with a recording medium such as a BD. The data associated with the recording medium is generally downloaded from an external device.

In association with the above-mentioned description, it is obvious to those skilled in the art that the local storage may directly read some permission data from the recording medium, and may generate system data (e.g., metadata) associated with record/reproduction operations of the recording medium, such that the system data may be stored in the local storage.

The term “binding unit” is indicative of a set of files stored in the local storage. Particularly, the binding unit is indicative of a set of information (i.e., information set) associated with a specific recording medium. In this case, the information set is replaced with, is added (or appended) to, or is merged with data contained in the recording medium by information of the binding unit manifest files, such that it can simultaneously reproduce data of the recording medium and data of the local storage. A detailed description of the binding unit will be described later.

For the convenience of description, data recorded in the recording medium is referred to as “original data”, data associated with the recording medium from among a plurality of data units stored in the local storage is referred to as “additional data”. The original data and the additional data construct content data.

FIG. 1 is a conceptual diagram illustrating a method and apparatus for reproducing data according to the present invention. Unified usages of the optical recording/reproducing 10 and peripheral devices are shown in FIG. 1.

The optical recording/reproducing device 10 can record/reproduce data in/from various optical discs having different formats. If necessary, the optical recording/reproducing device 10 can record/reproduce specific data in/from only a specific optical disc such as a BD, or can reproduce the data from the optical disc without recording the data in the same. It should be noted that the present invention exemplarily uses a BD-player capable of reproducing data from the BD or a BD-recorder capable of recording data in the BD in consideration of correlation between the BD and peripheral devices for the convenience of description. In association with the above-mentioned description, it is well known in the art that the optical recording/reproduction device 10 is also applicable to a drive embedded in a specific device such as a computer.

The optical recording/reproducing device 10 records or reproduces data in/from the optical disc 30, receives an external input signal, performs a signal process on the received signal, and transmits the signal processed result to the external display 20, such that a user can view the signal processed result on the display 20. In this case, there is no limitation in a receivable external signal. For example, representative external input signals may be determined to be a DTV (Digital multimedia broadcasting TV)-associated signal and an Internet-associated signal, etc. Specifically, the Internet is indicative of a communication network to which a user easily gains access, such that the user can download specific Internet data using the optical recording/reproducing device 10, and can use the downloaded data.

In association with the above-mentioned description, a person for providing content data used as an external source is generally referred to as a content provider (CP).

When original data is recorded in the optical disc 30 seated in the optical recording/reproducing device 10, and additional data associated with the original data is present in other storage places (e.g., Internet), the present invention aims to reproduce the original data and the additional data at the same time.

For example, it is assumed that multiplexed AV (Audio/Video) streams are recorded as the original data recorded in the optical disc, and additional data for use in the Internet is an audio stream different from an audio stream (e.g., Korean) of the original data. In this case, some users may download a specific audio stream (e.g., English) acting as additional data from the Internet, may desire to reproduce the downloaded audio stream along with the AV stream acting as original data, or may desire to reproduce only the additional data. In order to implement the above-mentioned desires of the users, correlation between the original data and the additional data must be established, and there is needed a systemized method for managing/reproducing the above-mentioned data according to a user request.

For the convenience of description, although a signal recorded in the disc is referred to as the original data, and other signals existing in the outside of the disc are referred to as the additional data, it should be noted that the original data and the additional data classified according to their data acquisition methods are not limited to only specific data.

Generally, additional data may be indicative of audio data, presentation graphic (PG) data, interactive graphic (IG) data, or text subtitle, etc., but the additional data may also be indicative of a multiplexed AV stream including the above-mentioned data and video data. In other words, data associated with the original data simultaneously existing in the outside of the optical disc may act as additional data.

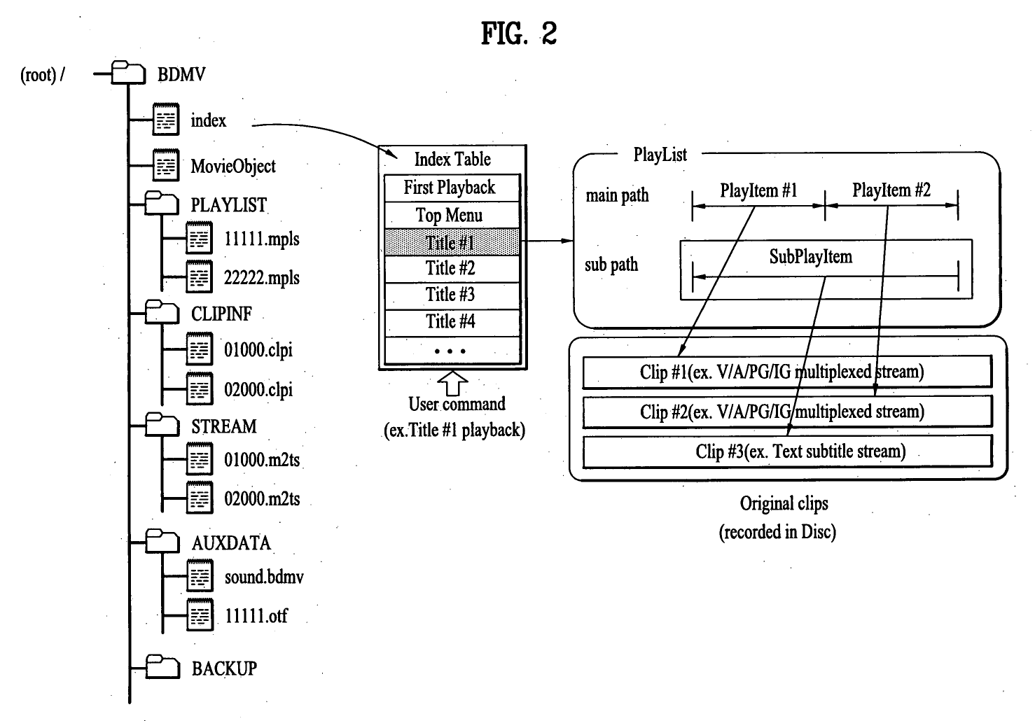

In order to satisfy the above-mentioned user requests, a predetermined file structure must be established between the original data and the additional data. Accordingly, a file structure and data record structure for use in the BD will hereinafter be described with reference to FIGS. 2□3.

FIG. 2 is a conceptual diagram illustrating a file structure for reproducing/managing the original data recorded in an optical disc, and a method for reproducing a specific title according to the file structure.

Referring to FIG. 2, the file structure according to the present invention includes one or more BD directories (BDMV) under a single root directory. The BD directory (BDMV) includes not only an index file “index” acting as a general file (i.e., an upper file) capable of guaranteeing user interactivity, but also the above-mentioned object. The file structure includes a variety of directories for storing information of actual data recorded in a disc and other information associated with a method for reproducing the data, for example, a playlist directory (PLAYLIST), a clip information directory (CLIPINF), a stream directory (STREAM), an auxiliary directory (AUXDATA), and a backup directory (BACKUP). The above-mentioned directories and a variety of files included in the directory will hereinafter be described.

The AUXDATA directory includes an additional data file for reproducing data of the disc. For example, the AUXDATA directory includes a “Sound.bdmv” file for providing a user with sound data when an interactive graphic function is executed, and an “11111.otf” file for providing the user with font information when data of the disc is reproduced.

The stream directory (STREAM) includes a plurality of AV stream files recorded in a disc according to a specific format. Generally, individual streams are recorded using an MPEG-2 based transport packet, and the stream directory (STREAM) uses extension names of stream files (01000.m2ts and 02000.m2ts) as a specific extension name “*.m2ts”. Particularly, if video/audio/graphic information from among the above-mentioned streams is multiplexed, the multiplexed information is called an AV stream, and a single title is composed of at least one AV stream file.

The clip information (Clip-info) directory (CLIPINF) is composed of a plurality of clip-info files (01000.clpi and 02000.clpi) connected to the above-mentioned stream files on a one-to-one basis. Particularly, the clip-info files (*.clpi) record attribute information and timing information of the stream files (*.m2ts) therein. The clip-info files (*.clpi) connected to the stream files (*.m2ts) on a one-to-one basis are generically named a “Clip”. In other words, this means that a single clip is indicative of data composed of a stream file (*.m2ts) and a clip-info file (*.clpi).

The playlist directory (PLAYLIST) includes a plurality of playlist files (*.mpls). Each playlist file (*.mpls) includes one or more playitems (PlayItem) and one or more sub-playitems (SubPlayItem). Each playitem (PlayItem) and each sub-playitem (SubPlayItem) are adapted to designate a playing interval during which a specific clip is reproduced. The playitem (PlayItem) and the sub-playitem (SubPlayItem) include information associated with a specific clip to be reproduced, i.e., information associated with a reproduction start time (IN-Time) and other information associated with a reproduction termination time (OUT-Time) of the specific clip.

In association with the above-mentioned description, a process for reproducing data using at least one playitem (PlayItem) in the playlist file is referred to as a main path, and a process for reproducing data using individual sub-play items (SubPlayItem) is referred to as a sub-path. The playlist file must contain a single main path. The playlist file may contain at least one sub-path according to the presence or absence of the sub-playitem (SubPlayItem) as necessary.

In conclusion, the playlist file acts as a basic reproduction/management file unit contained in overall reproduction/management file structures for reproducing a desired clip by combination of one or more playitems (PlayItem).

The backup directory (BACKUP) stores a plurality of duplicate files, i.e., a duplicate file (also called “copied files”) of the index file “index” storing information associated with disc reproduction, a duplicate file of the object file “MovieObject”, duplicate files of all playlist files (*.mpls) contained in the playlist directory (PLAYLIST), and duplicate files of all clip-info files (*.clpi) contained in the clip-info directory (CLIPINF). If the above-mentioned files (“index”, “MovieObject”, “*.mpls”, and “*.clpi”) are damaged, a disc reproduction process is also fatally damaged, such that the backup directory (BACKUP) is designed to pre-store duplicate files of the above-mentioned files as backup files.

In association with the above-mentioned description, a method for reproducing a specific title using the above-mentioned disc file structure is shown in FIG. 2.

If a user enters a title reproduction command in association with a title used as an index file (also called “index table”), reproduction of the title begins. A detailed description thereof will hereinafter be described.

The index file (index.bdmv) includes first playback information “First Playback” indicative of information associated with a first reproduction image when data of a corresponding disc is loaded, top menu information “Top Menu” for providing a menu image, and at least one title information “Title #1 □Title #n”.

When original data indicative of recording-medium data and additional data indicative of external input data are combined with each other, the present invention aims to record directory information in the recording medium in order to match a disc acting as the recording medium with a local storage binding unit, such that the aforementioned index file can be used as a directory-information record area, and a detailed description thereof will be described at a later time.

If the disc 30 is loaded in the optical recording/reproducing device 10, title menu information associated with the index table is provided to the user via the display 20. If the user selects a specific title or a specific menu contained in a menu image, data reproduction begins according to a scenario pre-defined by a disc manufacturer. In other words, if the user enters a command for reproducing a specific title (e.g., title #1), a specific playlist file is executed according to a command contained in the object file (MovieObject) of the reproduction/management file structure. Thereafter, one or more clips (e.g., Clip #1 □ Clip #3) constructing the title #1 are reproduced by a specific playitem and/or sub-playitem contained in the playlist file according to the playlist file information.

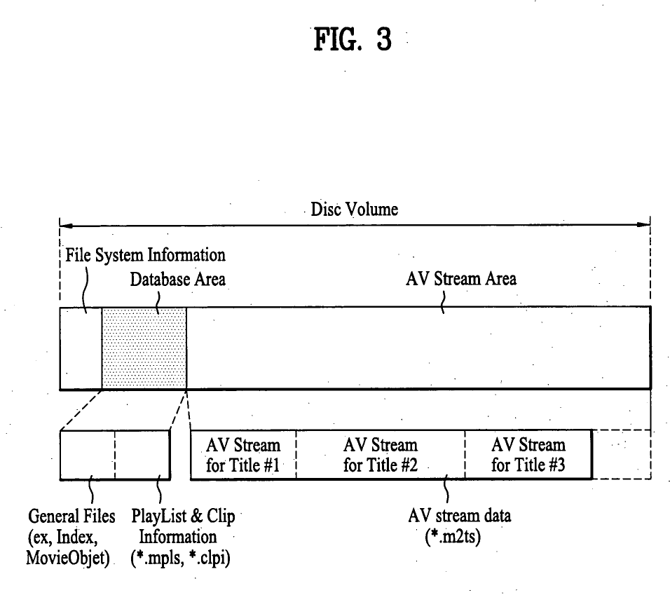

FIG. 3 is a structural diagram illustrating a data record structure recorded in a recording medium according to the present invention. In more detail, FIG. 3 shows a disc record format of information associated with the file structure and an area in which directory information is to be recorded. Specifically, the aforementioned directory information is indicative of disc-author directory (i.e., org_ID and org_shared) information and disc directory (i.e., disc_ID and disc_shared) information, which must be recorded in the disc to bind or combine a disc package with a local storage binding unit downloaded from an external CP.

As shown in FIG. 3, from the viewpoint of an inner area of the disc, the above-mentioned disc structure sequentially includes a file system information area, a database area, and an AV stream area.

The file system information area is indicative of an area in which system information for managing overall files is recorded. The database area includes a general file area (General Files) for recording an index file (index) and an object file (MovieObject) and a Playlist & Clip area for recording a playlist file (*.mpls) and a clip-info file (*.clpi) to reproduce a recorded AV stream (*.m2ts). The AV stream area records a plurality of streams composed of audio data, video data, and graphic data, etc. Particularly, it should be noted that data recorded in the AV stream area may be determined to be original data as previously stated above.

According to the present invention, if the recording medium is loaded in the optical recording/reproducing device, the optical recording/reproducing device searches for a binding unit associated with the loaded recording medium from among binding units stored in the local storage contained in the optical recording/reproducing device, such that it binds or combines the retrieved binding unit with the recording medium. As a result, a virtual package is formed, such that the optical recording/reproducing device reproduces data of the recording medium and/or data of the local storage using the formed virtual package.

The present invention provides a recording medium for recording directory information therein. For example, in order to reproduce data of the recording medium and local storage data associated with the recording medium, directory (org_ID) information for identifying individual content providers (CPs) or individual disc authors and disc directory (disc_ID) information for identifying individual discs are recorded in the recording medium.

In this case, the most important thing is which one of areas contained in the recording medium must store both the aforementioned org_ID information for identifying individual content providers and the aforementioned disc_ID information for identifying individual discs.

In association with the above-mentioned description, the org_ID information for identifying individual CPs and the disc_ID information for identifying individual discs are generically named “Directory Information”.

The present invention describes a variety of directory information record areas according to a plurality of preferred embodiments.

Firstly, a directory information record area according to a first preferred embodiment can be accessed by a resident application of the optical recording/reproducing device, can record directory information in a database area commonly used by the HDMV title and the BD-J title.

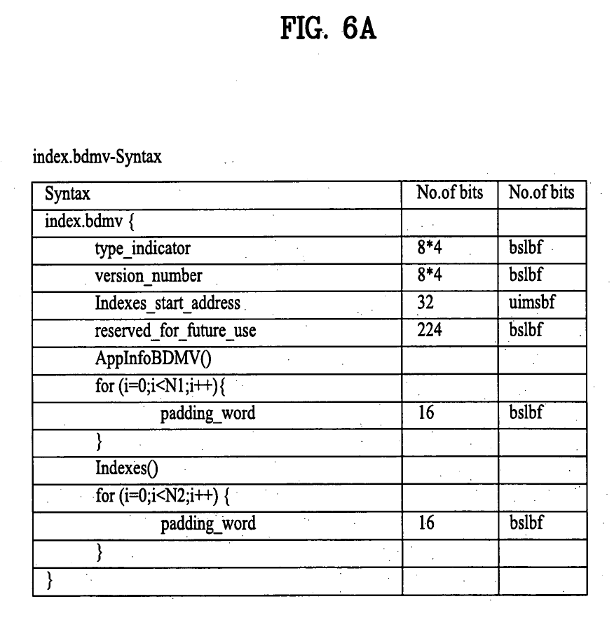

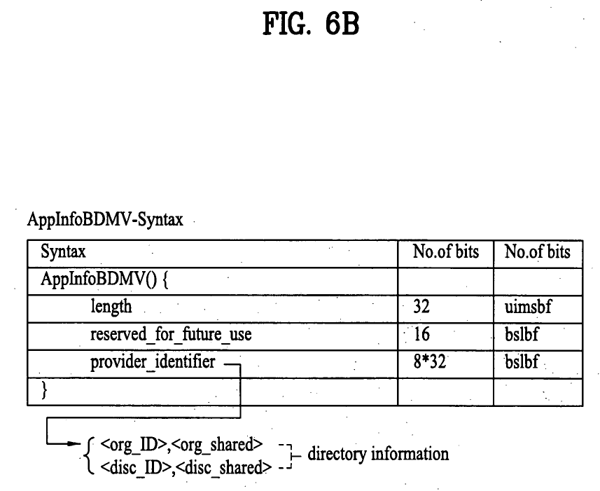

Secondly, a directory information record area according to a second preferred embodiment can record directory information in an index file (Index) of the database area. Specifically, the directory information can be recorded in a provider_identifier field contained in the index file (Index). A detailed description of the directory information record area according to the second preferred embodiment will be described with reference to FIGS. 6A-6B.

Thirdly, directory information (not shown in FIG. 3) can be recorded in a Burst Cutting Area (BCA) located at the innermost part of the disc after the manufacturing process is completed.

Fourthly, directory information can also be recorded in a reserved area contained in a Lead_in area of the disc acting as the recording medium.

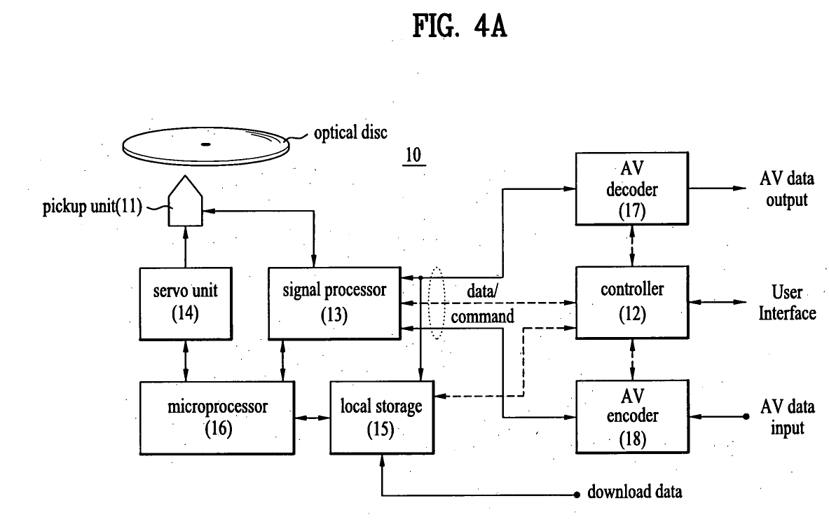

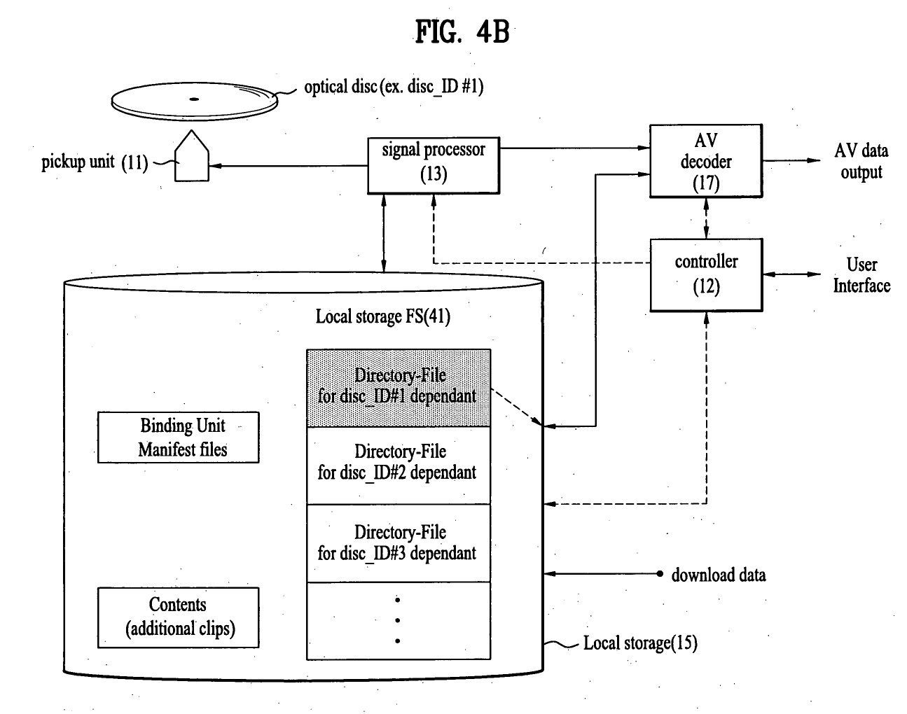

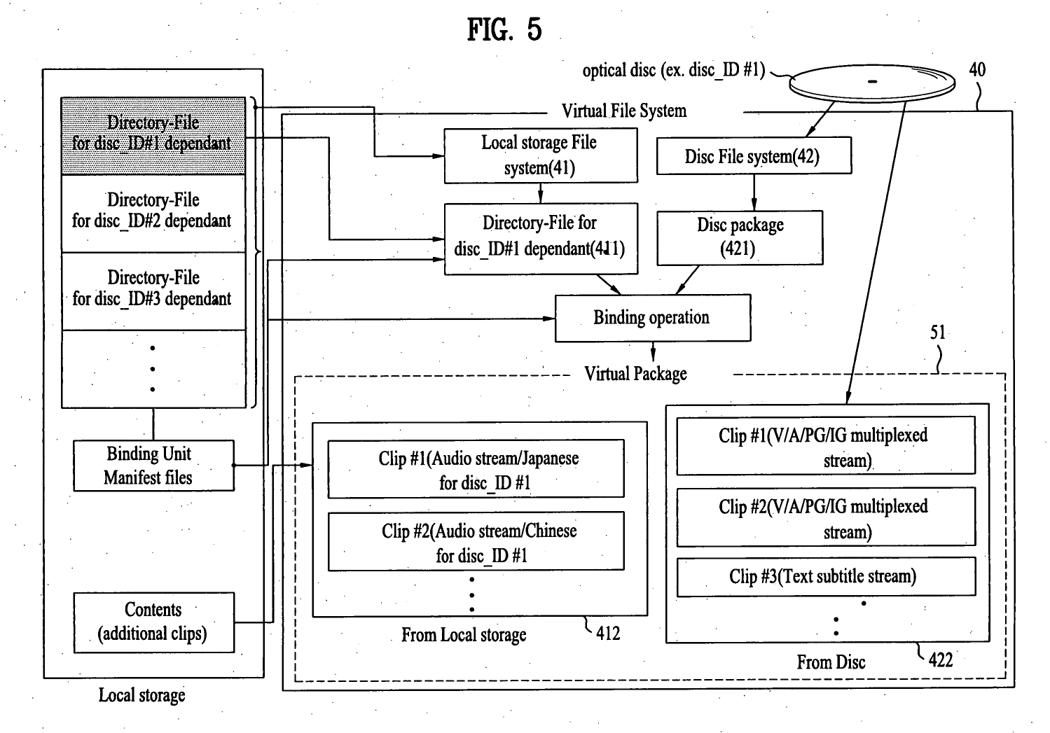

FIG. 4A is a block diagram illustrating the optical recording/reproducing device 10 according to the present invention.

Referring to FIG. 4A, the optical recording/reproducing device 10 includes a pickup unit 11, a servo unit 14, a signal processor 13, a local storage 15, and a microprocessor 16. The pickup unit 11 reproduces original data recorded in the optical disc and management information including reproduction/management file information. The servo unit 14 controls operations of the pickup unit 11. The signal processor 13 receives a reproduction signal from the pickup unit 11, restores the received reproduction signal to a desired signal value, or modulates a signal to be recorded into another signal recorded in the optical disc, such that it transmits the restored or modulated result. The local storage 15 stores data. The microprocessor 16 controls overall operations of the above-mentioned components.

Individual directories contained in the local storage file structure are created by a Java application, and are also named by the Java application.

A controller 12 downloads additional data from outside of the optical disc upon receiving a command from a user, stores the downloaded additional data in the local storage 15, and configures a binding unit using Binding Unit Manifest Information recorded in Binding unit manifest files of the local storage. In addition, the controller 12 configures a virtual file structure (hereinafter referred to as a virtual package) using the binding unit manifest information recorded in the binding unit manifest files, such that it can reproduce data contained in the recording medium and data contained in the local storage. The controller 12 reproduces the original data and/or the additional data using the virtual package upon receiving a request from a user.

The controller 12 determines the presence or absence of the presence or absence of a binding unit associated with the recording medium according to directory information of a loaded disc. If the presence of the binding unit associated with the recording medium is determined, the controller 12 combines the binding unit with the disc package, and forms a virtual package. Otherwise, if the absence of the binding unit associated with the recording medium is determined, the controller 12 forms a new file structure according to the aforementioned disc directory information, downloads additional data, forms a new binding unit, and combines the new binding unit with the disc package, such that it forms a virtual package.

The virtual package formed by the controller 12 includes at least one virtual playlist including a playitem capable of reproducing a plurality of clips.

The AV decoder 17 finally decodes output data (i.e., original data and/or additional data) upon receiving a control signal from the controller 12, and provides the user with the decoded result.

The AV encoder 18 converts an input signal into a specific format signal (e.g., an MPEG2 transport stream) upon receiving a control signal from the controller 12, and transmits the converted result to the signal processor 13.

The new virtual package may be stored in the local storage 15 such that it can be re-used in future. Also, the new virtual package may be temporarily stored in an additional dynamic memory, and may then be used.

FIG. 4B is a block diagram illustrating an apparatus for reproducing data of an optical disc using a local storage from among overall components contained in the optical recording/reproducing device 10 shown in FIG. 4A according to the present invention.

Information stored in the local storage 15 will hereinafter be described. The local storage 15 according to the present invention stores file information (Directory-File for disc_ID #n dependent) including directories and files for every individual disc identification (ID) information, and a plurality of additional clips downloaded from an external part.

The local storage 15 may include binding unit manifest information for forming a binding unit of the local storage 15, and performing a binding operation associated with a disc package.

However, the aforementioned example assumes that the local storage 15 includes data downloaded from an external part. If the local storage 15 has no download data downloaded from the external part, the Java application constructs directories and files of individual disc IDs using individual disc directory information, and stores data according to the constructed structure.

Specifically, the local storage 15 may include a plurality of file information units (Directory-File for disc_ID #n dependent) to cope with different discs. Therefore, the local storage 15 additionally requires a file system for managing the above-mentioned file information units. Specifically, the file system is also referred to as a local storage file system 41, and the local storage file system 41 is indicative of a system for managing all files stored in the local storage 15.

Therefore, if an optical disc (e.g., disc_ID #1) of a specific disc ID (disc_ID) is loaded in the optical recording/reproducing device 10, the controller 12 contained in the optical recording/reproducing device 10 recognizes ID information of the disc using the pickup unit 11 and the signal processor 13. If the local storage 15 stores file information, the controller reads binding unit file information equal to the loaded disc ID information from among all file information units stored in the local storage 15, forms a virtual package by binding (or combining) the read information and the disc package, and reproduces both the original data of the disc and the additional data of the local storage using the formed virtual package.

In this case, corresponding disc ID information confirmed by the controller 12 is given as specific information (e.g., directory information) according to the present invention. The above-mentioned directory information can include the following four directory names. A first directory name from among the four directory names is indicative of an “org_ID” directory name for identifying individual content providers (CPs). A second directory name from among the four directory names is indicative of an “org_shared” directory name capable of being shared by content providers (CPs). A third directory name from among the four directory names is indicative of a “disc_ID” directory name for identifying individual discs. A fourth directory name from among the four directory names is indicative of a “disc_shared” directory name capable of being shared by discs manufactured by the same content provider (CP). In association with the above-mentioned description, the “org_shared” name and the “disc_shared” name from among the aforementioned four directory names can be selectively provided by the controller 12.

A method for forming the virtual package according to the present invention will hereinafter be described with reference to FIG. 5.

FIG. 5 is a conceptual diagram illustrating a method for forming the virtual package according to the present invention.

Referring to FIG. 5, if a specific disc is loaded in the optical recording/reproducing device 10 on the condition that the information and contents shown in FIG. 4B are stored in the local storage 15, the optical recording/reproducing device 10 reads the file system information 41 contained in the local storage 15, and at the same time reads disc file system information 42 including the file structure recorded in the disc, resulting in the creation of the VFS. In more detail, the virtual file system (VFS) is indicative of a file system virtually formed to manage both the file system contained in the local storage 15 and the other file system of the loaded disc.

The optical recording/reproducing device forms a new virtual package to simultaneously reproduce original data recorded in the disc and additional data recorded in the local storage using the above-mentioned virtual file system (VFS). For this purpose, the optical recording/reproducing device 10 reads file information (Directory-File for disc_ID #1 dependent) associated with the disc (e.g., disc_ID #1) from the file system, forms a binding unit according the read binding unit manifest information, reads the formed binding unit, and performs a binding operation for replacing the read file information with a disc package of the loaded disc (disc_ID #1) or appending the read file information to the disc package.

In association with the above-mentioned description, the binding unit manifest file according to the present invention includes a list (i.e., Files and Titles relation List) indicative of a relationship between files and titles; Name Mapping information for performing mapping of all files contained in the binding unit to form the virtual package; Progressive Playlist information for progressive playlists; and Credential information.

Specifically, the above-mentioned name mapping information is used when file structure data of the local storage forms the binding unit or when the binding unit is combined with the disc package.

The virtual package formed by the above-mentioned binding operation is indicative of a file structure for reproducing/managing an original clip 422 and an additional clip 412. The original clip 422 is composed of original data recorded in the disc. The additional clip 412 is composed of additional data recorded in the local storage.

FIGS. 6A˜6B show exemplary areas for recording directory information in a recording medium. Specifically, FIGS. 6A˜6B show examples for recording directory information in the index table (i.e., index file “Index.bdmv”) according to the second preferred embodiment of the present invention.

FIG. 6A shows an index file (Index.bdmv) for storing index table information in the BD directory (BDMV) of the disc package shown in FIG. 2. The index file (Index.bdmv) is composed of two objects (i.e., “Indexes( )” and “AppinfoBDMV( )”).

The aforementioned “Indexes( )” object stores user operation commands such as “MenuCall” and “TitleSearch”, navigation commands such as “Jump Title”, and information of an automatic execution method for automatically executing the “FirstPlayback” command when the disc is loaded in the optical recording/reproducing device. The aforementioned “AppinfoBDMV( )” object will hereinafter be described with reference to FIG. 6B.

FIG. 6B shows an example in which directory information recorded in a recording medium is recorded in the “AppinfoBDMV( )” object contained in the index file (Index.bdmv).

The “AppinfoBDMV( )”) object stores common parameters commonly used in a top level so as to implement a disc application.

The “provider_identifier” field contained in the “AppinfoBDMV( )”) object is indicative of a field equipped with a CP-specific identifier, and is adapted to designate a disc author or content provider (CP) of a corresponding disc.

According to the present invention, the above-mentioned first to fourth directory names are recorded in the above-mentioned “provider_identifier” field. In other words, the “org_ID” directory name, the “org_shared” directory name, the “disc_ID” directory name, and the “disc_shared” directory name are recorded in the “provider_identifier” field.

In brief, the present invention records directory information in the “provider_identifier” field contained in the “AppInfoBDMV” field of the index file (Index.bdmv), reads binding unit information associated with the loaded recording medium from a binding unit stored in the local storage, forms a virtual package, such that it can reproduce original data stored in the recording medium or the disc and additional data stored in the local storage.

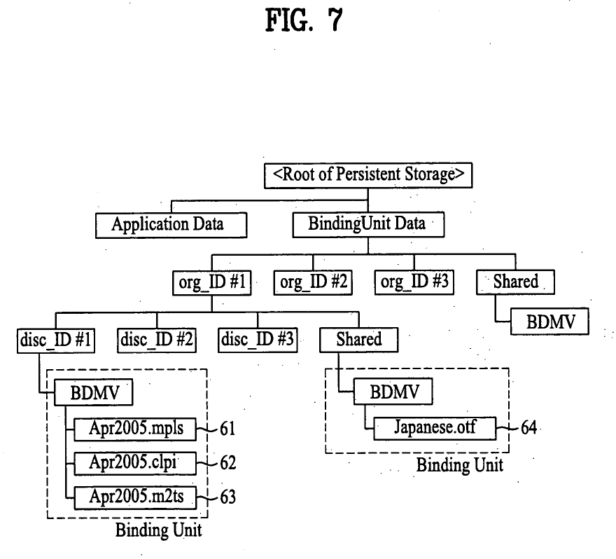

A method for forming a local storage file structure and a virtual package will hereinafter be described with reference to FIGS. 7˜8.

FIG. 7 is a conceptual diagram illustrating a relationship for forming a virtual package according to the present invention.

Referring to FIG. 7, the local storage file structure includes an “Application Data” directory and a “BindingUnit Data” directory in a lower directory of the root directory (Root of Persistent Storage). The “Application Data” directory and the “BindingUnit Data” directory store application data. The aforementioned “BindingUnit Data” directory includes a plurality of organization directories (i.e., org_ID #1, org_ID #2, and org_ID #3 directories) indicative of disc authors, and an “org_shared” or “Shared” directory shared by disc authors. The “org_ID #1” directory indicative of a specific disc author includes a plurality of disc-specific directories (i.e., disc_ID #1, disc_ID #2, and disc_ID #3) for identifying discs manufactured by the specific disc author, and a “shared” or “disc_shared” directory shared by the discs.

The BD directory (BDMV) is located under the “disc_ID #1” directory. The BD directory (BDMV) includes a playlist file (Apr2005.mpls) 61, a clip-info file (Apr2005.clpi) 62, and a stream file (Apr2005.m2ts) 63. All files 61, 62, and 63 contained in the BD directory (BDMV) are indicative of a single binding unit.

The “Shared” directory includes the other BD directory (BDMV) equipped with an auxiliary data file (Japanese.otf) 64 acting as another binding unit.

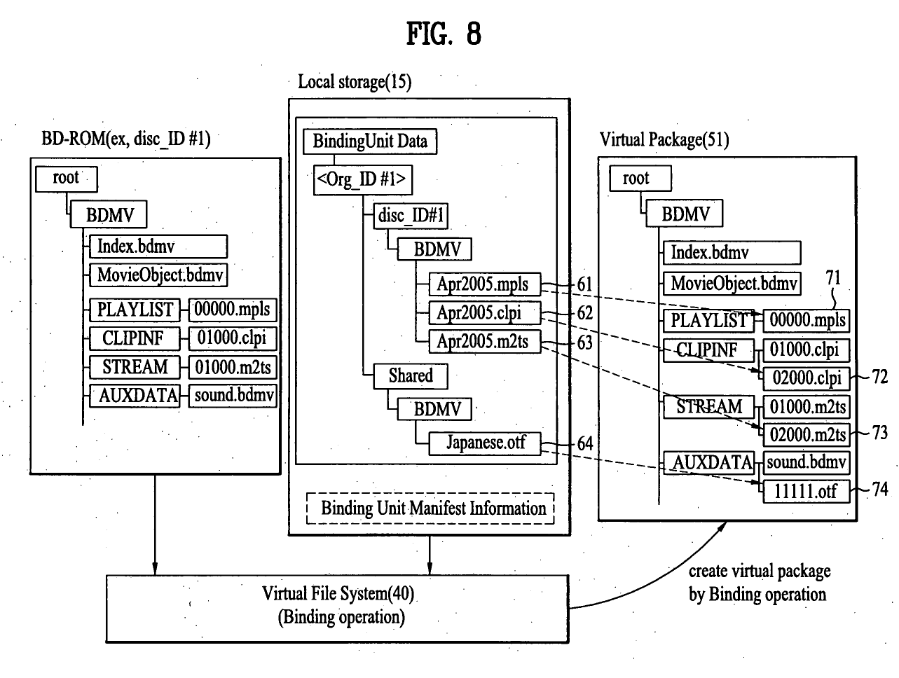

For example, if a recording medium or disc is loaded in a player indicative of an optical recording/reproducing device, the player reads local storage binding unit information shown in FIG. 7 using directory information (i.e., org_ID #1, disc_ID #1, and disc_shared) recorded in the recording medium, and forms a virtual package. A method for forming the virtual package will hereinafter be described with reference to FIG. 8.

FIG. 8 is a conceptual diagram illustrating a method for forming a virtual package using a virtual file system (VFS) on the basis of a file structure according to the present invention.

Referring to FIG. 8, a specific file structure (i.e., the disc package of FIG. 2) is recorded in the loaded disc, and may be referred to as a disc package. A local storage file system 41 is contained in the local storage. The local storage file system 41 includes a binding unit combined with the loaded disc (e.g., disc_ID #1), and Binding Unit Manifest files.

In association with the above-mentioned description, although the binding unit is basically similar to the disc file structure (i.e., the disc package), it should be noted that the binding unit cannot be operated as a reproduction/management file by itself, differently from the disc package.

If it is assumed that the binding unit is designed to perform data reproduction by itself, this data reproduction is similar to data reproduction of the local storage, such that the above-mentioned operations of the binding unit are contrary to the purpose of the present invention for simultaneously reproducing both original data recorded in the disc and additional data recorded in the local storage.

Therefore, the virtual file system (VFS) uses name mapping information contained in the binding unit manifest file information, and performs a binding operation for combining a binding unit associated with the loaded disc with the disc package of the loaded disc using the disc directory information, such that it forms a new virtual package.

For example, according to the disc package (org_ID #1 and disc_ID #1) of the disc shown in FIG. 8, the BDMV directory acting as a lower directory of the root directory includes an index file (index.bdmv), an object file (MovieObject.bdmv), a playlist file (00000.mpls), a clip-info file (01000.clpi), a stream file (01000.m2ts), and an AUXDATA file (sound.bdmv). Under the aforementioned condition of the disc package, the binding unit associated with the loaded disc (e.g., org_ID #1 and disc_ID #1) includes the “disc_ID #1” directory and the disc-shared directory (Shared) in the “org_ID #1” directory. The BDMV directory acting as a lower directory of the “disc_ID #1” directory includes a specific playlist file (Apr2005.mpls) 61, and clips (i.e., a clip-info file (Apr2005.clpi) 62 and a stream file (Apr2005.m2ts) 63) managed by the playlist file (Apr2005.mpls) 61. The disc-shared directory (Shared) includes an auxiliary data file (Japanese.otf) 64. Under the above-mentioned condition, the method for forming the virtual package is as follows.

The name mapping information of the binding unit manifest information according to the present invention is indicative of name- and location-information of binding unit files in the virtual package. A playlist file (Apr2005.mpls) 61 is changed (or modified) to a playlist file (00000.mpls) 71 of the playlist directory (PLAYLIST) in the virtual package, a clip-info file (Apr2005.clpi) 62 is changed to a clip-info file (02000.clpi) 72 of the clip-info directory (CLIPINF) in the virtual package, a stream file (Apr2005.m2ts) 63 is changed to a stream file (02000.m2ts) 73 of the stream directory (STREAM) in the virtual package, and an AUXDATA file (Japanese.otf) 64 is changed to an AUXDATA file (11111.otf) 74 of the auxiliary data directory (AUXDATA) in the virtual package. The name mapping information contained in the binding unit manifest information includes list information of files associated with file locations.

Therefore, when the virtual file system (VFS) performs the binding operation, if the binding operation is performed according to the name mapping information recorded in the binding unit manifest files of the local storage 15 and the virtual package is formed by the binding operation, the resultant file structure is as follows.

The virtual package 51 includes the BDMV directory acting as a lower directory of the root directory. The BDMV directory includes an index file (Index.bdmv), an object file (MovieObject.bdmv), a playlist directory (PLAYLIST), a clip-info directory (CLIPINF), a stream directory (STREAM), and an auxiliary data directory (AUXDATA). The playlist directory (PLAYLIST) includes a playlist file (00000.mpls) 71 acting as a substitute for the playlist file of the binding unit, the clip-info directory (CLIPINF) appends a clip-info file (02000.clpi) 72 to the clip-info file (01000.clpi) of the recording medium, the stream directory (STREAM) appends a stream file (02000.m2ts) 73 to the stream file (01000.m2ts) of the recording medium, and the AUXDATA directory (AUXDATA) appends an AUXDATA file (11111.otf) 74 to the AUXDATA file (sound.bdmv) of the recording medium, such that the virtual package 51 is formed.

In association with the above-mentioned description, the index file (index.bdmv) and the object file (MovieObject.bdmv), which act as upper files of the virtual package, may be updated in conventional index and object files (Index.bdmv and MovieObject.bdmv) contained in the disc on the basis of the newly-formed virtual playlist file (00000.mpls) 71. Specifically, if a title is changed to another title by the playlist file (00000.mpls) 71 contained in the virtual package (e.g., if a new title is added, a conventional title is deleted, or a title reproduction scenario is changed to another scenario), the aforementioned index and object files may be updated on the basis of the newly-formed virtual package.

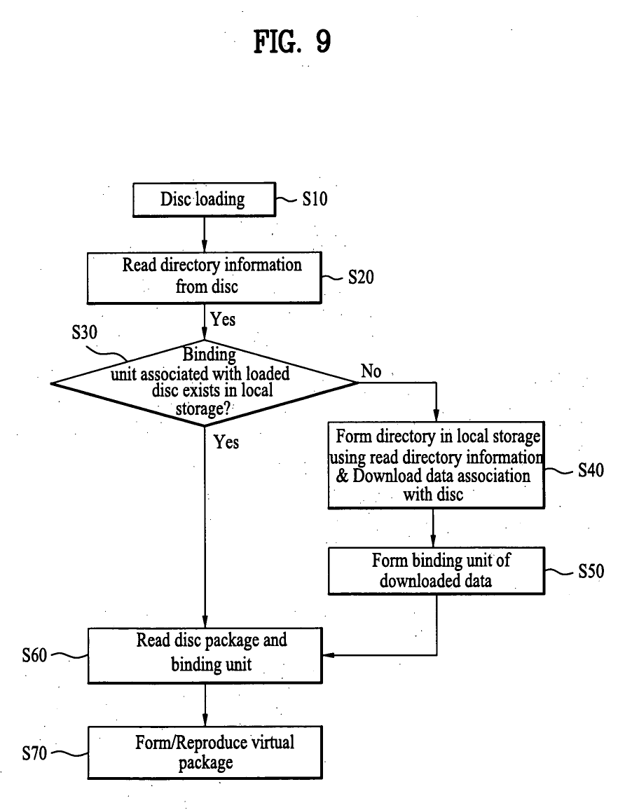

Therefore, original data indicative of recording medium data and additional data indicative of local storage data are reproduced according to the above-mentioned virtual package, and a detailed description thereof will hereinafter be described with reference to FIG. 9.

FIG. 9 is a flow chart illustrating a method for reproducing data from a recording medium using a local storage. Specifically, FIG. 9 is a flow chart illustrating a method for reproducing data downloaded from an external part simultaneously with reproducing data of the recording medium, according to the present invention.

Referring to FIG. 9, if a disc acting as a recording medium is loaded in an optical recording/reproducing device at step S10, the optical recording/reproducing device reads recording medium data equipped with various directory information from the loaded recording medium at step S20. In this case, the directory information is indicative of disc-author information (i.e., org.ID and org_shared) and disc directory information (i.e., disc_ID and disc_shared).

The optical recording/reproducing device determines whether a binding unit associated with the loaded recording medium is contained in the local storage on the basis of the read directory information at step S30. In other words, the optical recording/reproducing device recognizes disc_ID information from data stored in the local storage. It is preferable that the directory information is recorded in any one of the BCA area, the Lead-in area, and the index file area of the recording medium.

If no binding unit associated with the loaded recording medium exists in the local storage at step S30, the optical recording/reproducing device allows the Java application to form a plurality of directories in the local storage using the read directory information, and downloads the data associated with the recording medium at a specific location appropriate for the directory information at step S40.

The optical recording/reproducing device forms the binding unit according to the binding unit manifest file information upon receiving the downloaded data at step S50.

If the binding unit associated with the loaded recording medium exists in the local storage at step S30, or if the formed binding unit is found at sep S50, the optical recording/reproducing device reads the disc package and the local storage binding unit at step S60.

The virtual file system (VFS) forms a virtual package in association with the disc package and the local storage binding unit, and reproduces the formed virtual package, such that original data stored in the recording medium and additional data stored in the local storage are reproduced at sep S70.

In the meantime, before additional data is downloaded from the content provider CP after the recording medium has been loaded, the optical recording/reproducing device determines whether type information of the loaded recording medium indicates a specific state in which data can be downloaded from the aforementioned CP.

As apparent from the above description, a method and apparatus for reproducing data from a recording medium using a local storage according to the present invention can effectively reproduce original data recorded in a recording medium and additional data, resulting in the creation of more convenient functions for a user.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A recording medium comprising:
a first area for storing content data; and
a second area for storing first identification (ID) information capable of identifying a content provider (CP) and second identification (ID) information capable of identifying the corresponding recording medium manufactured by the content provider (CP).

2. The recording medium according to claim 1, wherein the ID information is given as a directory name.

3. The recording medium according to claim 2, wherein the directory name indicative of the content provider (CP) is indicative of an organization ID (org_ID) directory acting as a CP-specific directory.

4. The recording medium according to claim 3, wherein the directory name indicative of the content provider (CP) further includes an organization shared (org_shared) directory acting as a CP-shared directory.

5. The recording medium according to claim 2, wherein the directory name indicative of the recording medium is indicative of a disc-specific (disc_ID) directory.

6. The recording medium according to claim 5, wherein the directory name indicative of the recording medium further includes a disc-shared (disc_shared) directory.

7. The recording medium according to claim 1, wherein the second area is indicative of a database area.

8. The recording medium according to claim 7, wherein the second area is indicative of an index file (Index.bdmv) contained in the database area.

9. The recording medium according to claim 8, wherein the second area is indicative of a provider identifier (provider_identifier) field contained in the index file (Index.bdmv).

10. The recording medium according to claim 1, wherein the second area is indicative of a Burst Cutting Area (BCA).

11. The recording medium according to claim 1, wherein the second area is indicative of a Lead-in area.

12. The recording medium according to claim 1, wherein the second area is indicative of a file system information area.

13. A method for reproducing data from a recording medium using a local storage comprising the steps of:
a) reading a directory name for identifying a content provider recorded in the recording medium and a directory name for identifying the recording medium;
b) recognizing a binding unit contained in a local storage directory having the same directory name as the read directory name;
c) binding the binding unit with files contained in the recording medium, and forming a virtual package; and
d) reproducing content data stored in the recording medium and content data stored in the local storage using the virtual package.

14. A method for reproducing data from a recording medium using a local storage comprising the steps of:
a) reading a directory name for identifying a content provider recorded in the recording medium and a directory name for identifying the recording medium;
b) forming a directory having the same name as the read directory name in the local storage, downloading content data associated with the recording medium in the local storage directory, and storing the downloaded content data in the local storage directory;
c) determining a binding unit on the basis of the downloaded content data, binding the determined binding unit with files contained in the recording medium, and forming a virtual package; and
d) reproducing content data stored in the recording medium and content data stored in the local storage using the virtual package.

15. An apparatus for reproducing data from a recording medium using a local storage comprising:
a local storage for storing downloaded content data; and
a controller which reads a directory name for identifying a contents provider recorded in the recording medium and a directory name for identifying the recording medium, binds a binding unit contained in a local storage directory having the same directory name as the read directory name with files contained in the recording medium, forms a virtual package, and reproduces content data stored in the recording medium and/or content data stored in the local storage using the virtual package.

16. An apparatus for reproducing data from a recording medium using a local storage comprising:
a local storage for storing downloaded content data; and
a controller which reads a directory name for identifying a content provider recorded in the recording medium and a directory name for identifying the recording medium, forms a local storage directory having the same directory name as the read directory name, stores the downloaded content data in the local storage directory, determines a binding unit on the basis of the downloaded content data, binds the determined binding unit with files contained in the recording medium, forma a virtual package, and reproduces content data stored in the recording medium and/or content data stored in the local storage using the virtual package.
